(19) United States
(12) Patent Application Publication
(10) Pub. No.: US 2015/0142677 A1
(43) Pub. Date: May 21, 2015

(54) METHOD AND APPARATUS FOR DETERMINING A METRIC FOR A PREDICTED OPERATIONAL STATUS OF A PRODUCT

(71) Applicant: Cellco Partnership d/b/a Verizon Wireless, Basking Ridge, NJ (US)

(72) Inventors: Siva PATMAN, Edison, NJ (US); William Dakota COMMONS, Pennington, NJ (US); Ramakrishna KANNAMANGALAM, Piscataway, NJ (US); Vijayakumar PANDIARAJAN, Canton, MI (US)

(73) Assignee: Cellco Partnership d/b/a Verizon Wireless, Basking Ridge, NJ (US)

(21) Appl. No.: 14/086,477

(22) Filed: Nov. 21, 2013

(51) Int. Cl. G06Q 30/00

(52) U.S. Cl. CPC G06Q 30/016
USPC 705/304

(57) ABSTRACT

An approach for predicting potential reliability or performance issues associated with a product and presenting various options to address those potential issues includes determining one or more parameters associated with a transaction related to a product. The approach also includes obtaining, in response to the transaction and based on the one or more parameters, a metric describing a predicted operational status of the product. Further, the approach includes initiating a presentation, based on the metric, of one or more potential actions associated with the transaction and related to the product.

### BACKGROUND INFORMATION

To maintain or improve customer base and business conditions, companies (e.g., sellers, re-sellers, original equipment manufacturers (OEMs), etc.) involved in providing products to their customers may also need to provide customer service associated with their offered products. For example, an electronics store may provide various technical and sales related services for a range of products sold, rented, leased, etc. at the store. But as the type or the number of offered products may change, the companies need to continuously train their staff in understanding the offered products so they may provide a proper level of service for their customers where services may be in person, via online sessions, via phone calls, or the like. Further, with a potentially increasing number of product offerings with various complexity, the customers may request for various and frequent customer service, which could require additional company resources to address those enquiries and service requests. However, with numerous product offerings and customer enquiries, it is possible that any unresolved or frequent product issues could negatively impact customer experience, customer loyalty, and business efficiency/profitability. For instance, a customer may purchase a product (e.g., a mobile device, a television set, an audio headset, etc.) from the electronic store, and later, he may return to the store requesting technical support on an actual or a perceived product issue where he may intend to return or exchange the product.

Based on the foregoing, there is a need for efficient methods to predict potential reliability or performance issues associated with a product and present various options to address those potential issues.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of predicting potential reliability or performance issues associated with a product and presenting various options to address those potential issues, according to one embodiment;

FIG. 2 is a diagram of the components of a product transaction analysis platform, according to one embodiment;

FIG. 3 is a flowchart of a process for determining parameters, a metric, and actions associated with a product transaction, according to one embodiment;

FIG. 4 is a flowchart of a process for determining various rates and for managing the metric, according to one embodiment;

FIG. 5 is a flowchart of a process for calculating a product reliability rate, according to one embodiment;

FIG. 6 illustrates a graphical representation of a metric, according to one embodiment;

FIG. 7 illustrates a standard deviation curve of a product transaction probability distribution, according to one embodiment;

FIG. 8 illustrates a metric table associated with transactions on a product, according to one embodiment;

FIG. 9 illustrates a graphical representation of a plurality of transactions on a product, according to one embodiment;

FIG. 10 illustrates a user interface showing various information associated with transactions on a product, according to one embodiment;

FIG. 11 is a diagram of a computer system that can be used to implement various exemplary embodiments; and

FIG. 12 is a diagram of a chip set that can be used to implement an embodiment of the invention.

### DESCRIPTION OF THE PREFERRED EMBODIMENT

An apparatus, method and software for predicting potential reliability or performance issues associated with a product and presenting various options to address those potential issues are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

In the following discussion, an entity or entities of a merchant, a company, or a manufacturer may interchangeably be referred to and may be associated with offering various products to customers. Further, a product may refer to a certain product model, which may be offered by one or more entities, wherein a product model may include a plurality of same/similar product items where each product item may be identified by a unique identifier. Furthermore, the products may be offered for sale, rent, lease, lending, etc. at a physical location and/or via a virtual online portal. Additionally, a transaction associated with a product (e.g., item, model) may include a sale, a return, an exchange, a servicing, a troubleshooting, or the like. Although, some examples may refer to one or more electronic products, the disclosed methods may be applicable to various non-electronic products as well.

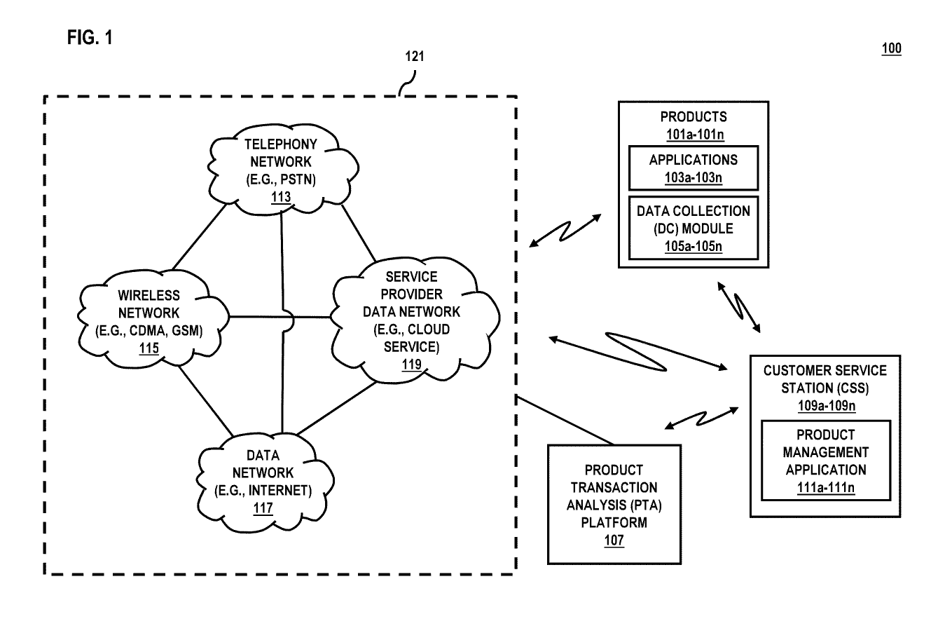

FIG. 1 is a diagram of a system for predicting potential reliability or performance issues associated with a product and presenting various options to address those potential issues. As previously discussed, companies (e.g., sellers, resellers, manufacturers, etc.) that provide various products (e.g., a mobile device, a television set, a gaming console, etc.) to consumers and organizations may also provide customer service on those products. For example, an electronics store may sell, rent, lease, or lend a mobile phone to a customer, and after the customer has taken delivery of the mobile phone, he may request customer service/support for understanding, identifying, or resolving any issues or questions associated with configuring, using, or troubleshooting that mobile phone. Generally, a customer may acquire a product at a physical merchant location or he may order it via an online merchant and receive a delivery of the product, at home, at the office, etc. Later, the customer may request and receive customer service at the physical location or via an online or phone-based customer service support center. For instance, a customer may purchase a laptop computer from an online or a physical merchant location and upon receiving the laptop computer, the customer may contact the merchant with any questions or issues regarding the laptop computer. In one example, a customer service representative (CSR) may be able to provide answers or resolutions at a merchant store, via a phone call, or via an online chat session. In some instances, an issue reported by a customer may be an actual issue (e.g., a hardware failure) or it may be an issue perceived to be real by the customer (e.g., due to a certain configuration at the product and not a failure). For example, the customer calling about an issue with the laptop computer may be having a difficulty with configuring the laptop computer and there may be no known actual issues with the laptop computer; however, in some cases there may be an actual issue. In some scenarios, a CSR may be able to provide a satisfactory solution to a customer service request, but in some instances the customer may need to return the product to the merchant for further troubleshooting or service. However, as companies may offer a wide variety of products and various models of each product, the companies may require additional resources (e.g., staff, equipment, etc.) and could incur additional costs (e.g., staff, equipment, warehouse location, shipping, etc.) to address all potential actual or perceived issues associated with their products. Therefore, it would be advantageous for the companies to be able to predict potential reliability or performance issues associated with a product and present various options to the customer and/or a CSR for addressing those potential issues before a product item is returned to a service center for additional troubleshooting or service.

To address these issues, system 100 of FIG. 1 provides the capability for tracking and analyzing product data to predict potential reliability or performance issues associated with a product and present various options to address those potential issues, according to one embodiment. As previously discussed, companies that offer products for sale, rent, lease, etc. may benefit from tracking product transaction data for determining potential reliability and performance issues associated with their products. In some instances, a customer having acquired a product from a company may contact the company and/or return to a physical location of the company with questions or issues associated with the product. Generally, a CSR of the company may assist the customer (e.g., in person or remotely) in determining what possible issues there may be. However, at times a CSR may not be able to readily determine what the issue with the product may be, in which case, the CSR may offer to exchange the product with a same or a different product, or the CSR may offer to send the customer's product to a company location for further analysis and troubleshooting. In some scenarios, a product being returned may not have any actual issues and any potential issues reported by the customer may be due to a lack of proper configuration or a proper usage of the product. In one example, if the CSR is aware that there are no known issues associated with that product, then he may spend some additional time and perform certain troubleshooting steps before shipping the product back to a company location (e.g., a service center) for further analysis and service. In doing so, the company may be able to save significant costs while providing a positive and satisfactory customer experience, e.g., customer issues are resolved and he has a working product.

The methods of the system 100 may enable a company to track any transaction data associated with a product, which may include various models and/or a plurality of product items within a single product model. For example, a merchant may carry tens or hundreds of mobile phone devices of various models by various manufacturers. The system 100 may track the transaction data associated with each of the mobile phone devices as well as track the accumulative transaction data associated with a given certain model. Further, the merchants may identify the products that have a high probability of having no trouble found (NTF) and request/suggest that those products are troubleshot before they are shipped back for replacement or testing. Furthermore, the merchant may determine appropriate actions for addressing any potential issues and present those actions to the merchant's CSRs for providing assistance to those customers who have acquired the product item that may have a known or a potential issue.

In various scenarios, the transaction data may include information on a frequency of transactions, average time between transactions, average transactions per product item and/or per product model, an accuracy of order fulfillment (e.g., products shipped to customers versus corresponding product orders received), location of transactions, manufacturer of the product, or the like. The transaction data may be analyzed by a variety of algorithms for determining various metrics that may be helpful in determining proper actions to address any potential issues associated with the product. In various examples, the transaction data may be collected from various sources associated with a merchant, with a product, with a customer, or the like. In various embodiments, the methods of the system 100 may partially or totally be implemented by one or more elements of the system 100, for example, by a service provider, by a merchant, by a manufacturer, or the like.

For the purpose of illustration, the system 100 may include one or more products 101a-101n (product or product item 101), which may include, execute, and utilize one or more applications 103a-103n (also referred to as applications 103), one or more data collection modules 105a-105n (also referred to as DC module 105).

In one embodiment, a product item 101 may include one or more modules for determining a user's location, for example, via location of the product item 101. The user's location can be determined by a triangulation system such as GPS, assisted GPS (A-GPS), Cell of Origin, or other location extrapolation technologies. Standard GPS and A-GPS systems can use satellites to pinpoint the location of a product item 101. A Cell of Origin system can be used to determine the cellular tower that a cellular product item 101 is synchronized with. This information provides a coarse location of the product item 101 because the cellular tower can have a unique cellular identifier (cell-ID) that can be geographically mapped. The location module 301 may also utilize multiple technologies to detect the location of the product item 101. Location coordinates (e.g., GPS coordinates) can give finer detail as to the location of the product item 101 when media is captured. In one embodiment, GPS coordinates may be stored as context information in a memory module and may be available for context processing via one or more modules at the product item 101 and/or via other entities of the system 100.

In one embodiment, a product item 101 may include one or more modules for finding horizontal orientation of the product item 101. A magnetometer is an instrument that can measure the strength and/or direction of a magnetic field. Using the same approach as a compass, the magnetometer is capable of determining the direction of a product item 101 using the magnetic field of the Earth. The front of a media capture device (e.g., a camera) can be marked as a reference point in determining direction. Thus, if the magnetic field points north compared to the reference point, then the angle of the product item 101 from the magnetic field is known. Simple calculations can be made to determine the direction of the product item 101. In one embodiment, horizontal directional data obtained from a magnetometer can be stored in a memory module, made available to other modules and/or applications 103 of the product item 101, and/or transmitted to one or more entities of the system 100.

In one embodiment, a product item 101 may include one or more accelerometer modules for determining vertical orientation of the product item 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a product item 101 is stationary, an accelerometer module can determine the angle the product item 101 is pointed as compared to Earth's gravity. In certain embodiments, a magnetometer module and an accelerometer module may be means for ascertaining a perspective of a user. This perspective information may be stored in a memory module, made available to other modules and/or applications 103 of the product item 101, and/or sent to one or more entities of the system 100.

In one embodiment, a product item 101 may capture and process data from one or more sensors (e.g., microphone, optical, Bluetooth, NFC, GPS, accelerometer, gyroscope, thermometer, etc.) to determine environmental (e.g., atmospheric) conditions surrounding the product item 101, user mood, location information, and various other information from a range sensors that may be available on one or more devices. For example, the sensors may detect conditions including humidity, temperature, geo-location, biometric data of the user, etc. In one example, the user mood may be determined based on emoticons used in various applications, types of internet sites accessed by the user, pressure sensors on the device, voice analysis during audio communications, or the like. Once again, this information can be stored in the memory module and shared with one or more modules or applications 103 of the product item 101 and/or one or more entities of the system 100. In one embodiment, the product item 101 may utilize a microphone and a camera sensor to capture audio signals, images, video available in the environment close to the product item 101. In one embodiment, the data captured by the sensors may be analyzed and compared with the transaction data to determine if there are any correlations. For example, the sensors' data may be analyzed to check for a pattern or a sequence of data which may have been collected prior to the last transaction involving a product item 101. For instance, the sensors' data may indicate a location, environmental conditions, movement of the device when a certain feature on the product item 101 was functioning or malfunctioning as indicated by the user of the product item 101. The analysis of the collected sensor data along with the transaction data may provide additional correlating information so that a merchant may be able to ascertain any potential causal issues associated with the product item 101 and provide a better customer service.

In one embodiment, a product item 101 may include a user interface for a user to interface with applications, modules, sensors, and the like at the product item 101. For example, the user interface may have outputs including a visual component (e.g., a screen), an audio component, a physical component (e.g., vibrations), and other methods of communication. User inputs can include a touch-screen interface, a scroll-and-click interface, a button interface, a microphone, etc. An input may be via one or more methods such as voice input, textual input, typed input, typed touch-screen input, other touch-enabled input, etc.

In one embodiment, a product item 101 may include a communication interface module for communicating with one or more entities of the system 100, for example, to submit a share information associated with one or more events or functional status at the product item 101. In various embodiments, the communication interface may facilitate communications via one or more wireless communication channels and protocols, for example, WLAN, RFID, NFC, Bluetooth Smart, Bluetooth, Ant+, Z-Wave, ZigBee, or the like, wherein the communication channels may be established via one or more sensors, transceivers, transmitters, receivers, wireless charging interface, or the like. Certain communications can be via methods such as an internet protocol, messaging (e.g., SMS, multimedia messaging service (MMS), etc.), or any other communication method (e.g., via a network system). In some examples, the product item 101 can send context information associated with the product item 101 to one or more entities of the system 100.

In one embodiment, the system 100 may include a product transaction analysis (PTA) platform 107 for tracking and analyzing various transaction information associated with various products associated with a merchant/company, a manufacturer, or the like. In one embodiment, the PTA platform 107 may include one or more standalone devices (e.g., a computer, a server, a computer/server farm, etc.) dedicated to provide services for tracking and analyzing the transaction information associated with the products 101.

In one embodiment, the system 100 may include one or more customer service stations 109a-109n (CSS 109), which may utilize one or more modules, applications, software, algorithms, or the like. In one embodiment, a CSS 109 may utilize a product management application 111 with various functionalities for providing customer service on various products. In various embodiments, a product management application 111 may collect various transaction data associated with a product item 101, a product model, a user, a customer, a manufacturer of a product item, and the like. For example, a CSS 109 may be utilized at a point-of-sale (POS) location (e.g., a merchant physical/online location) where the product items 101 may be offered for sale, rent, lease, lending, and the like. In one embodiment, a CSS 109 may be dedicated to one or more merchants where the collected transaction data may be shared with a merchant corresponding to one or more product items 101 offered by that merchant. In various embodiments, the CSS 109 may communicate with a product item 101 and/or one or more elements of the system 100 via one or more communication channels for receiving and sharing various data associated with a product item 101, a user, a customer, a merchant, a manufacturer, a service provider, or the like. In one embodiment, the product management application 111 may process various data items before sharing them with other elements of the system 100, for example, with the PTA platform 107. In one example, the processing may include an analysis, sorting, parsing, or the like, of the data items to determine product item information, user information, type of transaction, and the like. In one embodiment, the CSS 109 may determine one or more parameters (e.g., a return request, an exchange request, a product serial number, a product model number, etc.) associated with a transaction related to a product and share the parameters and/or any associated transaction data with the PTA platform 107. In various embodiments, a CSR may utilize the CSS 109 for interfacing with the PTA platform 107, with a product item 101, or one or more elements of the system 100. In one embodiment, the PTA platform 107 may present a probability metric or one or more options to a CSR via the CSS 109. For example, the metric or the options may provide various pieces of information and process steps so that the CSR may further diagnose any potential issues at a product item 101, wherein additional options and information may then be presented to the CSR upon completion of the diagnostics.

Furthermore, the system 100 may include a network system 121, which may include one or more networks, including a telephony network 113, a wireless network 115, a data network 117, a service provider data network 119, etc. By way of example, the networks 113, 115, 117, and 119 may be any suitable wireline and/or wireless network, which may be managed by one or more service providers. In one example, the networks 113, 115, 117, and 119 may be one or more elements in a network system 121, which may include various components and elements for providing a range of communication and network services. For example, telephony network 113 may include a circuit-switched network, such as the public switched telephone network (PSTN), an integrated services digital network (ISDN), a private branch exchange (PBX), or other like network. Wireless network 115 may employ various technologies including, for example, code division multiple access (CDMA), enhanced data rates for global evolution (EDGE), general packet radio service (GPRS), mobile ad hoc network (MANET), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 117 may be any local area network (LAN), metropolitan area network (MAN), wide area network (WAN), the Internet, or any other suitable packet-switched network, such as a commercially owned, proprietary packet-switched network, such as a proprietary cable or fiber-optic network.

Although depicted as separate entities, networks 113, 115, 117, and 119 may be completely or partially contained within one another, or may embody one or more of the aforementioned infrastructures. For instance, the service provider network 115 may embody circuit-switched and/or packet-switched networks that include facilities to provide for transport of circuit-switched and/or packet-based communications. It is further contemplated that networks 113, 115, 117, and 119 may include components and facilities to provide for signaling and/or bearer communications between the various components or facilities of system 100. In this manner, networks 113, 115, 117, and 119 may embody or include portions of a signaling system 7 (SS7) network, or other suitable infrastructure to support control and signaling functions.

By way of examples, the products 101 may communicate with other products via one or more proximity-based communication channels, or via one or more network service providers in the network system 121. Further, the applications 103 may include various applications for productivity, point-of-sale transactions, healthcare services, education, entertainment, social networking, web browser, communications, content sharing, multimedia applications, user interface (UI), map application, web client, or the like. In various scenarios, a CSR may determine, collect, and submit any transaction data associated with a product 101. For example, the CSR may determine or collect transaction data by performing a physical examination of the product item 101, using an interface device and application to communicate with the product item 101, asking a user about the functionality of the product item 101. Further, the CSR may submit the determined and collected transaction data via a CSS 109 to a merchant or its representative.

In one embodiment, a product item 101 may utilize a DC module 105 for determining and/or collecting data and/or content associated with the product item 101, one or more users of the product item 101, the applications 103, one or more content items (e.g., multimedia content), and the like. In addition, the product 101 can execute an application 103 that is a software client for storing, processing, and/or forwarding one or more information items to other components of the system 100. In various embodiments, the DC module 105 may include various sensors for detecting and capturing various signals, information, and contents, for example, audio, video, location information, Bluetooth signals, near field communication (NFC) signals, RFID signals, or the like. Further, the collected information, content, or signals may be shared, via the applications 103 with other products 101, PTA platform 107, or service providers in the network system 121.

It is noted that products 101 may be any type of electronic or mechanical product item, for example, a mobile terminal, a fixed terminal, or a portable terminal including a mobile handset, station, unit, device, multimedia computer, multimedia tablet, Internet node, communicator, desktop computer, laptop computer, Personal Digital Assistants (PDAs), smartphone, television set, or any combination thereof. It is also contemplated that the products 101 can support any type of interface for supporting the collection, presentment, or exchanging of data. In addition, the products 101 may facilitate various input means for receiving and generating information, including touch screen capability, keyboard and keypad data entry, voice-based input mechanisms and the like. Any known and future implementations of the products 101 are applicable. In certain embodiments, the products 101 may be configured to establish peer-to-peer communication sessions with each other using a variety of technologies, including near field communication (NFC), Bluetooth, ZigBee, infrared, etc. Also, connectivity can be provided via a wireless local area network (LAN). By way of example, a group of the products 101 may be configured to a common LAN so that each device can be uniquely identified via any suitable network addressing scheme.

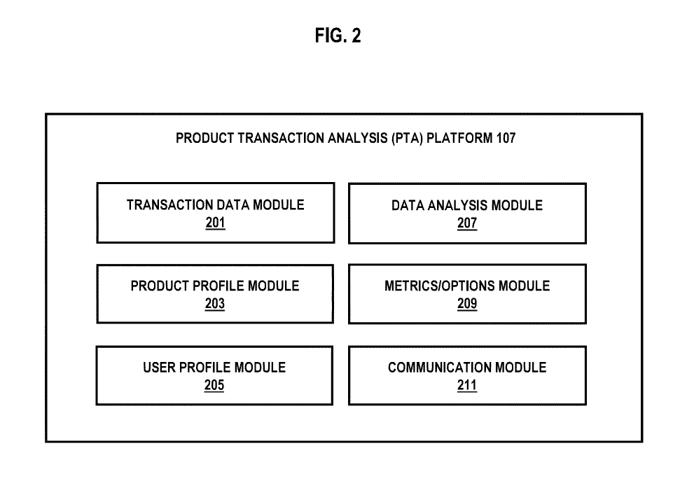

FIG. 2 is a diagram of the components of a product transaction analysis platform, according to one embodiment. By way of example, the PTA platform 107 may include one or more components for facilitating transaction analysis procedures. The components may be implemented in hardware, firmware, software, or a combination thereof and thus may be implemented in a tangible non-transitory manner. It is contemplated that the functions of these components may be combined in one or more components or performed by other components of equivalent functionality. In one embodiment, the PTA platform 107 may include a transaction data module 201, a product profile module 203, a user profile module 205, a data analysis module 207, a metrics/options module 209, and a communication module 211. The PTA platform 107 may be implemented as a platform and/or as one or more applications at a standalone device (e.g., a computer, a server, etc.), or it may be implemented at one or more elements of the network system 121 for providing its services to one or more parties associated with one or more products. In one embodiment, the PTA platform 107 may utilize one or more applications, software, algorithms, or the like for tracking and analyzing the transaction information, for determining one or more related metrics, and for presenting one or more potential actions.

In one embodiment, the transaction data module 201 may request and/or receive transaction data associated with one or more products 101. By way of example, the transaction data module 201 operates in connection with the communication module 211 to communicate with one or more CSSs 109 for requesting and/or receiving the transaction data. For example, a CSS 109 may provide the initial transaction data associated with a product item 101 and then continue to provide any subsequent transaction data, which may be associated with that product item 101 and/or with a product model associated with that product item 101. In one scenario, a CSS 109 may provide transaction data on a product item 101 when a customer contacts the product provider with any questions, issues, concerns, or the like. In various examples, the transaction data may indicate that a customer is requesting to return a product item 101, or is requesting for technical support, or is inquiring about a product fulfillment issue, or the like. In one embodiment, the transaction data module 201 periodically or intermittently may inquire with the CSSs 109 for transaction data associated with one or more products 101. In one example, the frequency of one or more inquiries may be based on a type of a product item 101 (e.g., new products, electronic devices, sale price of the product, etc.), location of a merchant of the product item 101, product model transaction history, and the like. In one embodiment, the transaction data module 201 may continuously monitor and log various transaction data from CSSs 109 associated with a product/service provider that is associated with one or more products 101.

In one embodiment, the user profile module 203 may include profile information associated with one or more users who may be using the product item 101. In one example, the user profile information may be provided via an administrative account at the product item 101 where some of the information may be restricted for access or for modification only by an administrative user. In one example, a user may have privileges to change some of the user profile information. In one scenario, a user profile may indicate user information, user preferences, user activity, user habits, or the like, which may be shared with a service or a product provider in accordance to permissions or privacy policy configured by the user of the product item 101. In one embodiment, a CSR may request from a user of a product item 101 for permission to access the user profile information associated with the product item 101.

In one embodiment, the product profile module 205 may include product information indicative of available resources, applications, services, functional status, events log, current configuration, last configuration, original configuration, transaction history, or the like. For example, a user may utilize various configurations or applications available at a product item 101 for performing various tasks. In one embodiment, a product profile may be associated with one or more user profiles who may share that product, wherein a user profile may indicate as to how, where, or when a user may have accessed or utilized the product. Additionally, the device profile may include or have access to information associated with various applications that a user may have used or attempted to use at/via the product. In one embodiment, the device profile may include location information where a product may have been utilized, stored, moved to, or the like. In one embodiment, the product profile module 205 may obtain an original or a recommended current product profile from a service provider and/or a manufacturer associated with the product.

The data analysis module 207 in conjunction with the other modules of the PTA platform 107 may process and analyze various data associated with various product items, product models, product manufacturers, user profile, product profile, and the like. In various embodiments, the data analysis module 207 may utilize various algorithms, applications, software, and the like for processing or analyzing the data and determine any potential transaction or event patterns. For example, the transaction data analysis may indicate that customers are returning a large number of a certain product item where the transaction data may be further compared to other data available for similar product items. Additionally, the transaction data may be correlated to other data associated with an owner/user of the product item, product profile, manufacturer information, and the like. In various scenarios, the data analysis may be continuous or periodical. In various embodiments, the data analysis may be performed based on various parameters defined by a merchant, a manufacturer, customer feedback on a product item, frequency of or the like.

In one embodiment, the metrics/options module 209 in conjunction with the data analysis module 207 may generate one or more metrics based on the data analysis, wherein the metric may describe one or more predicted operational status of the product. For example, an operational status may indicate that a product may exhibit one or more potential issues when under certain conditions. In various scenarios, a metric may include data on one or more transactions associated with a product item, a product model, or the like, for example, number of returns of a certain product item within a product model, number of product items sold, number of customers involved in the transactions, and the like. Additionally, the metrics/options module 209 may determine and recommend/present one or more options to a CSR for addressing one or more predicted potential issues. For example, the options may recommend that the CSR perform certain troubleshooting steps to further investigate a potential issue. In one embodiment, a CSR may present one or more of the options to a customer who may perform the troubleshooting steps, for example, when the customer is requesting the customer service via an online or a phone call session. In various scenarios, the options may present one or more steps for determining and alleviating one or more potential issues associated with the product item without having to return, exchange, or further troubleshoot the product item while providing for a better customer experience and reduced costs to the merchant/manufacturer of the product item.

In one embodiment, the communication module 211 may be utilized to communicate with various applications, modules, or components of the PTA platform 107 and/or the system 100 for monitoring, requesting, or receiving transaction data associated with a variety of products and for providing metrics, information, options, etc. to customers, users, service providers, manufacturers, and the like. In one scenario, the communication may be effectuated via a communication module available at a product item 101.

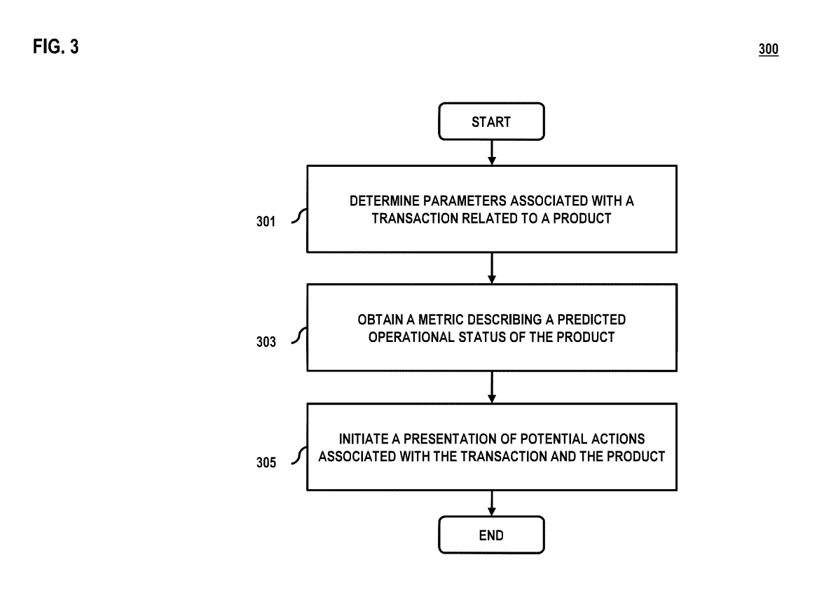

FIG. 3 is a flowchart of a process for determining parameters, a metric, and actions associated with a product transaction, according to one embodiment. For the purpose of illustration, process 300 is described with respect to FIG. 1. It is noted that the steps of the process 300 may be performed in any suitable order, as well as combined or separated in any suitable manner.

As shown in FIG. 3, in step 301, the PTA platform 107 may determine one or more parameters associated with a transaction related to a product. In one embodiment, the one or more parameters include a return transaction rate, a product order fulfillment accuracy, a product transaction frequency, a consumer information, a consumer location, a product type, a product manufacturer, or a combination thereof. In one embodiment, the parameters may be determined from the CSS 109. For example, the CSS 109 may log and report a sale, a return, or an exchange of a product as well as other parameters associated with the customer, customer feedback, any issues identified with the product, or the like. In one embodiment, the transaction is a return transaction, wherein the one or more potential actions include, for example, performing additional troubleshooting of the product, shipping the product to another location, or a combination thereof.

In step 303, the PTA platform 107 may obtain, in response to the transaction and based on the one or more parameters, a metric describing a predicted operational status of the product. In one embodiment, the PTA platform 107 may obtain a partial or a complete metric from another entity in the system 100, wherein a partial metric may be further completed by the PTA platform 107. For example, all or part of the metric may be generated by a cloud service provider 119 and obtained by the PTA platform 107 by communicating (e.g., SMS, email, a web page, etc.) with the service provider 119 via the network system 121. In one embodiment, the PTA platform 107 may analyze the one or more parameters (e.g., by use of algorithms, statistical software, etc.) in order to ascertain any potential issues that may be associated with a certain product item or a certain product model. Further, the PTA platform 107 may determine/generate a metric that may include one or more predicted operational statuses associated with the product. For example, the parameters may indicate that one or more customers have returned a certain product item over a certain period of time, wherein a CSR or a product service center may have logged one or more issues associated with the product item. In one scenario, the metric may include data indicative of the number of product items, the product models, etc. that a company may have in its inventory or under its control, wherein each product item or product model may have different statistical information.

In step 305, the PTA platform 107 may initiate a presentation, based on the metric, of one or more potential actions associated with the transaction and related to the product. In one embodiment, the PTA platform 107 may initiate the presentation at a CSS 109. In one scenario, the one or more potential actions may suggest or request for a CSR to follow a certain procedure to determine one or more issues, questions, operational status, etc. that may be associated with the product. For example, the metric may indicate that a certain product item is associated with one or more potential issues and the actions may suggest for the CSR to perform certain troubleshooting steps for determining if that certain product item is exhibiting any of the potential issues. In various embodiments, the metric may indicate that a potential issue may be due to an actual issue with the product item, configuration of the product item, usage of the product item, an accessory in use with the product item, or the like. In one example, the action may suggest for the CSR to return the product item to a company location for further analysis and service so that the CSR does not have to spend any additional time for trying to determine what a potential issue with the product item may be.

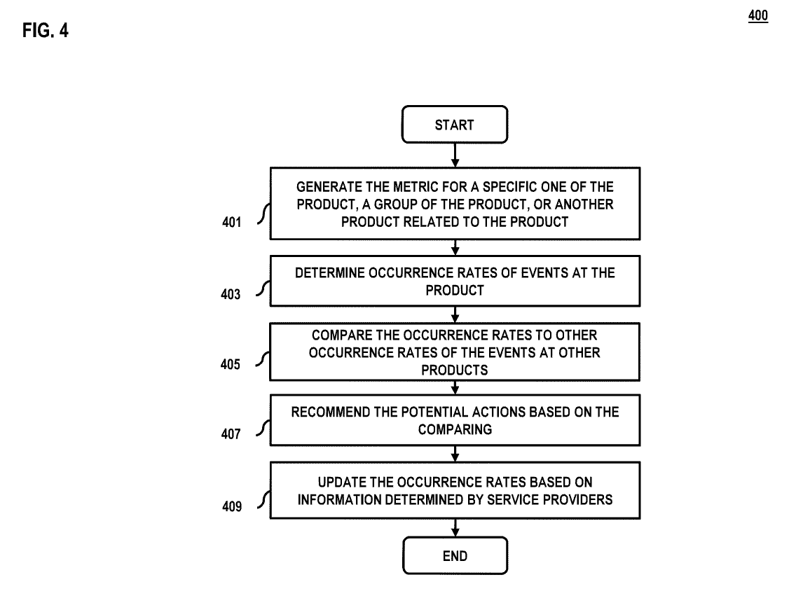

FIG. 4 is a flowchart of a process for determining various rates and for managing the metric, according to one embodiment. For the purpose of illustration, process 400 is described with respect to FIG. 1. It is noted that the steps of the process 400 may be performed in any suitable order, as well as combined or separated in any suitable manner.

As shown in FIG. 4, in step 401, the PTA platform 107 may generate the metric for a specific one of the product, a group of the product, another product related to the product, or a combination thereof. In one scenario, a merchant may be dealing with a plurality of product items within a same product model as well as a range of other products which may be related to the product item and/or to the product model. For example, a merchant may carry tens or hundreds of mobile devices that are of the same model, but each mobile device may uniquely be identified, e.g., by an identification number. In one embodiment, a metric may include information associated with a specific product item and/or with a group of product items within a product model. In one scenario, the metric may also include information on one or more other devices (e.g. accessories), which may be associated (e.g., used with) a certain product item or a product model. For example, the metric may indicate that various electric chargers, headsets, remote controllers, keyboards, toolset, lubricant, cover, or the like may be used with a product item. In one embodiment, the PTA platform 107 may determine any information associated with other products and analyze that information separately or in conjunction with the analysis of the information associated with a product item or a product model.

In step 403, the PTA platform 107 may determine one or more occurrence rates of one or more events at the product. In one embodiment, the PTA platform 107 may request to receive information associated with one or more events, which may occur at a specific product item or at a given product model, wherein the information may be utilized to determine a frequency rate for each of the events. For example, information at a mobile device may indicate that several power-cycle events have occurred during a certain period of time, wherein the analysis of these power-cycle events may provide additional information for determining the one or more actions that may be suggested to a CSR.

In step 405, the PTA platform 107 may compare the one or more occurrence rates to one or more other occurrence rates of the one or more events at one or more other products. In one scenario, the PTA platform 107 may compare the occurrence rate of an event at a certain product item to a potential occurrence rate of that event at one or more other product items, wherein the other product items may be the same, similar, or different than that certain product item. For example, a certain computer monitor may be exhibiting a certain distortion event when in use, and the PTA platform 107 may compare and determine if that distortion event has been reported and associated with another computer monitor of the same model and/or with another model.

In step 407, the PTA platform 107 may recommend the one or more potential actions based on the comparing. In one scenario, the PTA platform 107 may determine and recommend one or more potential actions based on one or more other actions which may have been determined and/or recommended for other product items or product models. For example, it is possible that a prior action recommended for a prior product item may be applicable to a current product item under evaluation by a CSR, by a customer, by a service center, or the like.

In step 409, the PTA platform 107 may update the one or more occurrence rates based on one or more information items determined by one or more service providers. In one embodiment, the PTA platform 107 may request and/or receive information from one or more service providers on one or more occurrence rates associated with a product item and/or a product model. For example, the information may be available from a service provider which may be providing third-party services for one or more products.

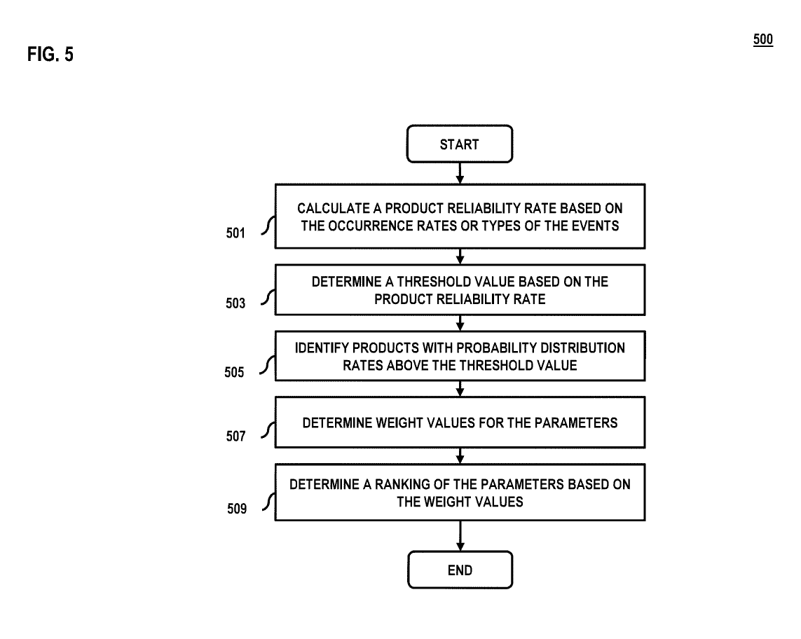

FIG. 5 is a flowchart of a process for calculating a product reliability rate, according to one embodiment. For the purpose of illustration, process 500 is described with respect to FIG. 1. It is noted that the steps of the process 500 may be performed in any suitable order, as well as combined or separated in any suitable manner.

As shown in FIG. 5, in step 501, the PTA platform 107 may calculate a product reliability rate based on the one or more occurrence rates, one or more types of the one or more events, or a combination thereof. In one scenario, a product reliability rate may be based on a frequency of one or more events at a product item and/or a product model, which may be utilized in determining and suggesting one or more actions for addressing the one or more potential issues with the product item and/or a product model. In another scenario, the reliability rate may include statistics on the types of the events associated with a product item and/or a product model.

In step 503, the PTA platform 107 may determine a threshold value based on the product reliability rate. In one embodiment, the PTA platform 107 may utilize the metric information and the product reliability rate to determine a threshold for a product item or a product model. For example, the threshold may be based on a certain percentage of a product model that may be associated with a frequency of events, one or more types of events, or the like, wherein a merchant may set the threshold value based on a desired target for testing product items 101 before they are made available for customer use. For instance, the threshold values may be set to correspond to a company's targets for reducing the number of product items returned to a company testing center.

In step 505, the PTA platform 107 may identify one or more products with probability distribution rates above the threshold value. In one embodiment, the PTA platform 107 may identify and select a product item or a product model that may have a probability distribution rate above the threshold value. For example, if a certain product item is above the threshold value, the PTA platform 107 may suggest to a CSR to return the product item to a company service center for additional analysis and service.

In step 507, the PTA platform 107 may determine one or more weight values for the one or more parameters. In one embodiment, the PTA platform 107 may process and analyze the various parameters and associate one or more weight values, which may indicate how they are used in determining the metric. In one scenario, the weight values may be determined based on a type of parameter, a type of event associated with the parameter, an operational status associated with the parameter, customer feedback, or the like. For instance, the weight values may set by a merchant of a product item in order to indicate significance of a transaction compared to other transactions, wherein the transactions may be associated with a product item and/or a product model. In one embodiment, the weight values may be set manually by a merchant or by a merchant representative (e.g., an expert evaluating available transaction data on a product item) per product item, per product item model, product item type. In another embodiment, the PTA platform 107 may utilize one or more conditional equations to dynamically determine the weight factors. For example, the equations may be based on one or more other elements of a metric, e.g., a transaction cycle number, the number of product items associated with the transaction cycle number, a type of product item, or the like.

In step 509, the PTA platform 107 may determine a ranking of the one or more parameters based on the one or more weight values. In one scenario, a ranking of the one or more parameters based on the one or more weight values may indicate how a parameter is utilized in determining the metric. For example, a parameter associated with a certain functional event may be ranked higher than other parameters so that proper actions may be determined for addressing the event. In one embodiment, a merchant may determine the ranking based on company criteria for meeting one or more company targets, for example, to maintain a certain product reliability rate associated with a certain product item type, model, transaction location, and the like.

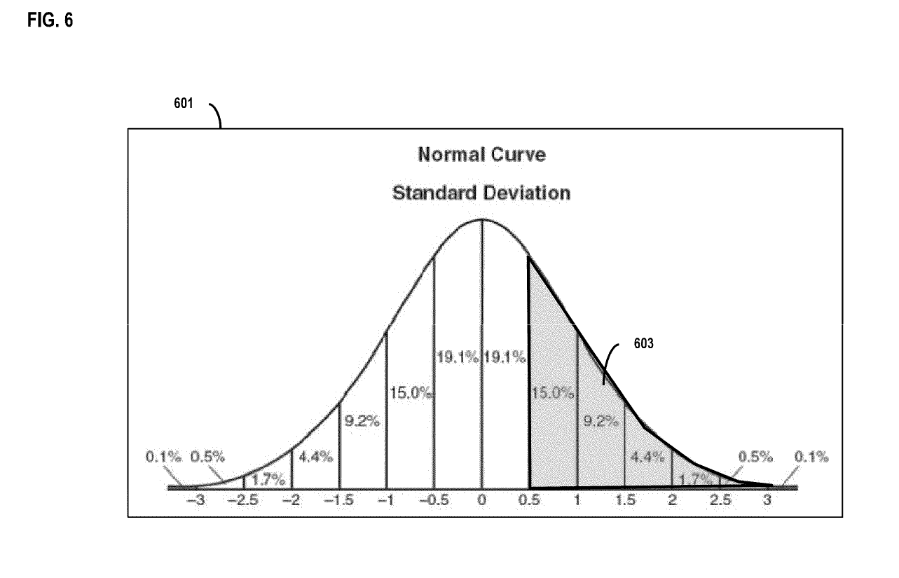

FIG. 6 illustrates a standard deviation curve of a product transaction probability distribution, according to one embodiment. In one scenario, a probability metric may utilize a plurality of variables that could potentially affect the likelihood that a testing of a certain product item 101 may result in a “No Trouble Found” (NTF) rating. In one embodiment, the PTA platform 107 may generate a probability distribution curve 601, wherein a product item 101 that is associated with parameters or transaction data above a certain threshold value 603 (e.g., 30%) may be recommended to be further analyzed/troubleshot before a CSR or a customer returns the product item 101 to a merchant, manufacturer, or a service provider. In various scenarios, the parameters may include average time between returns of a certain product item 101 or a product model, average return per product item 101, accuracy of order fulfillment, and the like.

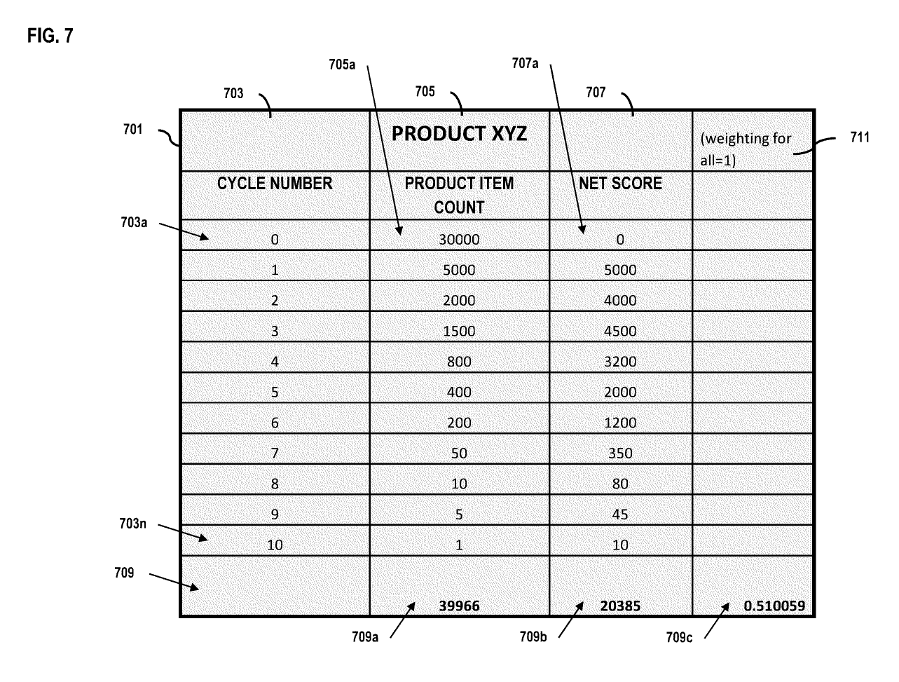

FIG. 7 illustrates a metric table associated with transactions on a product, according to one embodiment. In one scenario, a metric table 701 for a product model “XYZ” may present information on an average return per product item (e.g., a mobile phone, a tablet, etc.), which may include various data on a frequency of a transaction “cycle number” 703, “product item count” 705, and a resulting “net score “707”. In one embodiment, the cycle number 703 may indicate the number of times a product item 101 of the product model XYZ has been returned. For example, the cycle number 703a “0” indicates the number of product items in 705a (30000) had no transactions (e.g., not returns) after the initial delivery of the product items, and the two values 703a and 705a are multiplied to result in the net score at 707a, which is zero for this example. The process for completing the metric table 701 may continue for a predetermined number of transactions and/or data points, for example, until there are product items with 10 transaction cycle numbers 703n. At 709, the scores of the product item count 705 are summed at 709a and the net scores 707 are summed at 709b. Next the sum of net score 709b is divided by the product item sum 709a to yield an average transaction rate (e.g., average return of a certain product) of approximately “0.51” at 709c. In one scenario, a product model with a lower average return per device (ARPD) (e.g., less than 0.5) could indicate that it is more likely that such a product model would have nothing wrong with it than a product model with a higher (e.g., 3) ARPD. In various embodiments, a weight factor 711 may be flexible and may be adjusted to consider various factors and company preferences, for example, to account for a single product item with multiple transactions (e.g., one product item returned 10 times (1×10)) or for multiple product items with a single transaction (e.g., 10 product items each returned one time (10×1)). In the example metric of FIG. 7 the weight factor used is at one. In one embodiment, the weight factor may be higher or lower than one, which may be based on criteria defined by a merchant of a product item. For example, the merchant may associate a higher weight factor (e.g., 1.5, 2, 3, etc.) to a transaction of a product item which has had multiple transactions (e.g., one product item returned 10 times (e.g., 10×1×1.5)), and associate a lower weight factor (e.g., 0.75, 0.5, 0.25, etc.) to a transaction involving a product item for the first time (e.g., 1×1×0.5), which may indicate a lesser impact on an overall data analysis. In one embodiment, the weight values may be set manually by a merchant or by a merchant representative (e.g., an expert evaluating available transaction data on a product item) per product item, per product item model, per product item type. In another embodiment, the PTA platform 107 may utilize one or more conditional equations to dynamically determine the weight factors. For example, the equations may be based on one or more other elements of a metric, e.g., a transaction cycle number, the number of product items associated with the transaction cycle number, a type of product item, or the like.

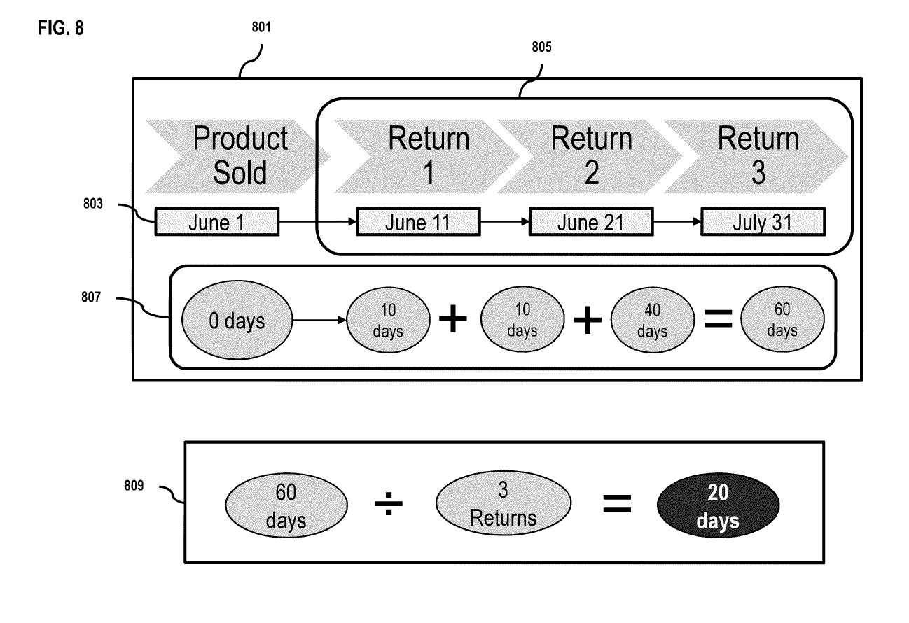

FIG. 8 illustrates a graphical representation of a plurality of transactions on a product item, according to one embodiment. Another example metric may be based on an average time between transactions (ATBR) (e.g., returns, exchanges, etc.) that is associated with a product item. In one scenario, a plurality of transactions are depicted in 801 where at 803 a product item is sold on June 1. Next, a plurality of additional transactions 805 are tracked indicating that there is a first return on June 11 (e.g. 10 days after the initial sale), a second return on June 21 (e.g., 10 days after the first return), and a third return on July 31 (e.g., 40 days after the second return), where 807 illustrates the time between each transaction for a total of three returns within 60 days. In 809, the ATBR is calculated to be 20 days. In one scenario, the calculated ATBR could useful to a merchant when comparing a product item with an ATBR of 20 days to a product item with an ATBR of one year, wherein a product item with an ATBR of days would be more likely to have various potential issues versus the one with the ATBR of one year.

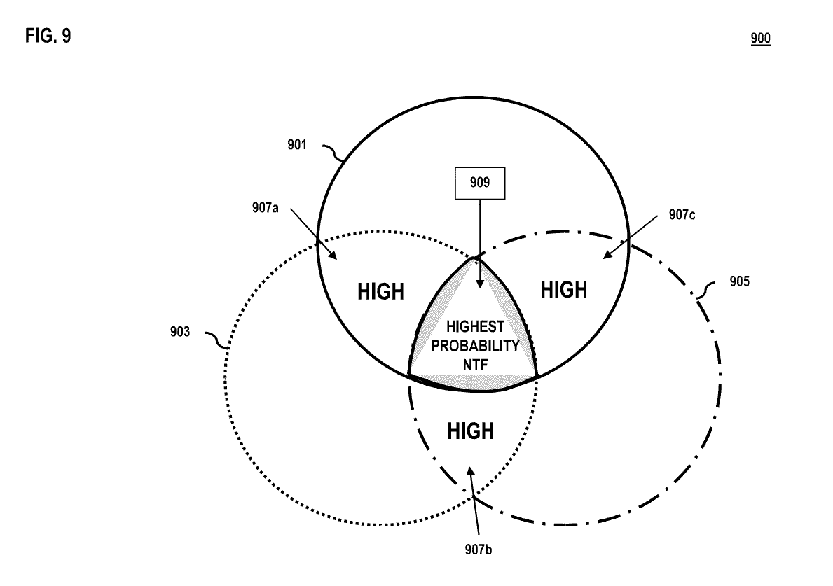

FIG. 9 illustrates a graphical representation of a metric, according to one embodiment. In one example, a Venn diagram 900 is utilized to illustrate various metric parameters: an order fulfillment accuracy rate 901, an ATBR 903, and an ARPD 905 where intersections of the different metric parameters 907a, 907b, and 907c may indicate a high probability that an analysis of a product item 101 associated with this metric representation would result in an NTF. Additionally, region 909 may indicate a highest probability that an analysis of the product item would yield an NTF. In various scenarios, the number of product items in each metric may be varied for including a larger or smaller sample size of the product items.

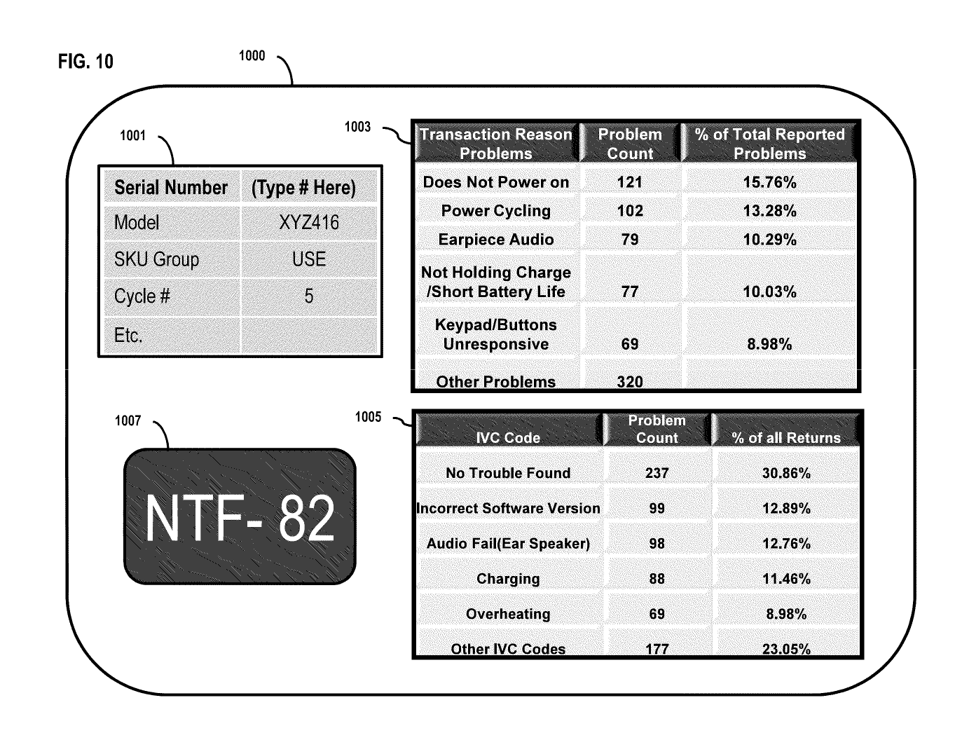

FIG. 10 illustrates a user interface at a customer service station showing various information associated with transactions on a product, according to one embodiment. In one embodiment, the user interface 1000 may be presented at a CSS 109 where a CSR may view and interact with various user interface elements 1001, 1003, 1005, 1007, or the like. In one example, the user interface element 1001 may be utilized to input or view information about a particular product item 101, for instance, a serial number, a model number, a SKU group, a cycle number, etc. In the user interface element 1003, various pieces of information associated with a transaction instance may be presented to and/or input by the CSR. For example, the user interface element 1003 may include information about potential problems associated with a product item 101 or an entire product model. In one scenario, the user interface element 1005 may include information about various diagnostics results and their corresponding calculated rates. For example, the diagnostics results may indicate that there were certain numbers of NTFs, product items with incorrect software version, overcharging, audio failure, etc. In one embodiment, the PTA platform 107 may present a calculated NTF rate in 1007 (e.g., an NTF of 82%), which would indicate to a CSR the likelihood of an NTF associated with a product item 101. Additionally, the calculated rate 1007 may also indicate to the CSR as to how thoroughly should the diagnostics of the product item be conducted before the product item is returned to the customer (e.g., in person) or as to when the product item should be shipped to a merchant service center (e.g., by the CSR or by the customer).

In one embodiment, a CSR may determine, based on the calculated NTF rate in 1007, one or more actions which should be performed. For example, a high NTF rate for a particular product item may be associated with a list of troubleshooting steps that the CSR would be requested to perform. In one embodiment, the NTF rate may suggest for the CSR to call a service center for additional directions on handling the transaction of the related product item. In one embodiment, a CSR may submit/transmit one or more notifications, based on a transaction conducted in person, online, by phone, or the like, to the PTA platform 107. For example, a notification may include information on the type of transaction, the product item serial number, the product model, the type of transaction, customer information, possible issues, any diagnostic actions by the CSR, or the like. In one embodiment, the CSS 109 may cause the submission/transmission of the one or more notifications. In one embodiment, a partial or a complete history of one or more transactions may be stored at a product item (e.g., an electronic device including onboard memory.)

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well known “opt-in” or “opt-out” processes as may be appropriate for the situation and type of information. Storage and use of personal information may be in an appropriately secure manner reflective of the type of information, for example, through various encryption and anonymization techniques for particularly sensitive information.

The exemplary techniques and systems presented herein enables predicting potential reliability or performance issues associated with a product and presenting various options to address those potential issues. As an advantage, the PTA platform may enable a company to predict potential reliability or performance issues associated with a product and present various options to its CSRs for addressing those potential issues before additional resources and costs may be expended on troubleshooting, returning, exchanging, or servicing the product.

The processes described herein for predicting potential reliability or performance issues associated with a product and presenting various options to address those potential issues may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

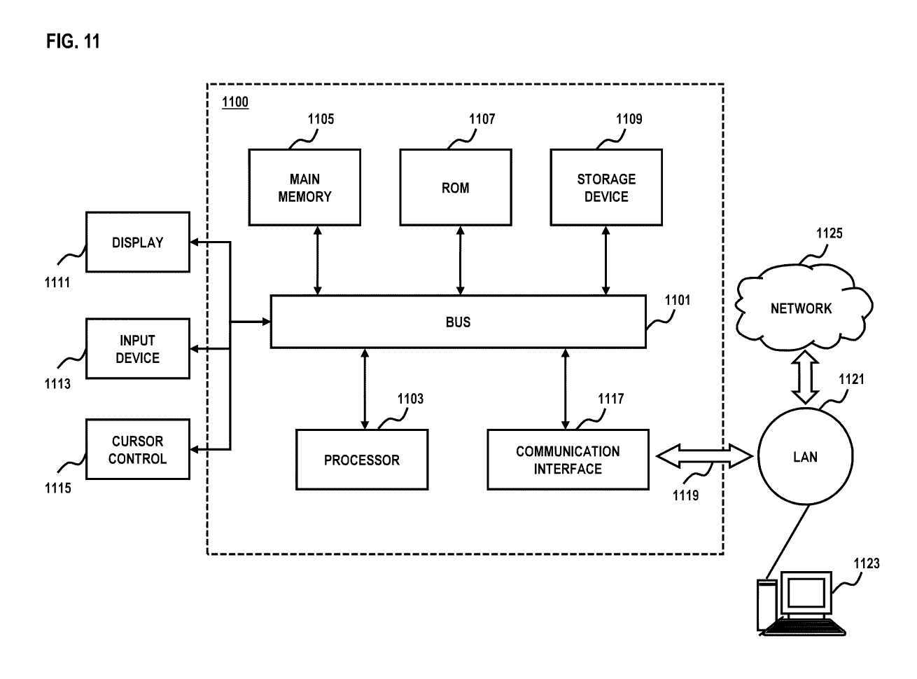

FIG. 11 illustrates computing hardware (e.g., computer system) upon which an embodiment according to the invention can be implemented. The computer system 1100 includes a bus 1101 or other communication mechanism for communicating information and a processor 1103 coupled to the bus 1101 for processing information. The computer system 1100 also includes main memory 1105, such as random access memory (RAM) or other dynamic storage device, coupled to the bus 1101 for storing information and instructions to be executed by the processor 1103. Main memory 1105 also can be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Mode (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 1121 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 1103 may execute the transmitted code while being received and/or store the code in the storage device 1109, or other non-volatile storage for later execution. In this manner, the computer system 1100 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

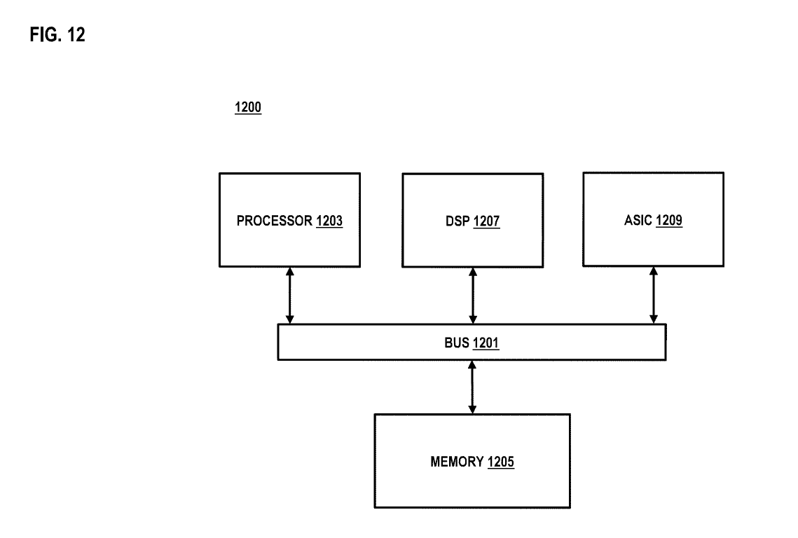

FIG. 12 illustrates a chip set 1200 upon which an embodiment of the invention may be implemented. Chip set 1200 is programmed to provide for predicting potential reliability or performance issues associated with a product and presenting various options to address those potential issues and includes, for instance, the processor and memory components described with respect to FIG. 11 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip. Chip set 1200, or a portion thereof, constitutes a means for performing one or more steps of FIGS. 3-5.

In one embodiment, the chip set 1200 includes a communication mechanism such as a bus 1201 for passing information among the components of the chip set 1200. A processor 1203 has connectivity to the bus 1201 to execute instructions and process information stored in, for example, a memory 1205. The processor 1203 may include one or more processing cores with each core configured to perform independently. A multi-core processor enables multiprocessing within a single physical package. Examples of a multi-core processor include two, four, eight, or greater numbers of processing cores. Alternatively or in addition, the processor 1203 may include one or more microprocessors configured in tandem via the bus 1201 to enable independent execution of instructions, pipelining, and multithreading. The processor 1203 may also be accompanied with one or more specialized components to perform certain processing functions and tasks such as one or more digital signal processors (DSP) 1207, or one or more application-specific integrated circuits (ASIC) 1209. A DSP 1207 typically is configured to process real-world signals (e.g., sound) in real time independently of the processor 1203. Similarly, an ASIC 1209 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1203 and accompanying components have connectivity to the memory 1205 via the bus 1201. The memory 1205 includes both dynamic memory (e.g., RAM, magnetic disk, writable optical disk, etc.) and static memory (e.g., ROM, CD-ROM, etc.) for storing executable instructions that when executed perform the inventive steps described herein to controlling a set-top box based on device events. The memory 1205 also stores the data associated with or generated by the execution of the inventive steps.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method of comprising:
determining one or more parameters associated with a transaction related to a product;
obtaining, in response to the transaction and based on the one or more parameters, a metric describing a predicted operational status of the product; and
initiating a presentation, based on the metric, of one or more potential actions associated with the transaction and related to the product.

2. A method of claim 1, wherein the transaction is a return transaction, and wherein the one or more potential actions include (1) performing additional troubleshooting of the product, (2) shipping the product to another location, or (3) a combination thereof.

3. A method of claim 1, further comprising:
generating the metric for a specific one of the product, a group of the product, another product related to the product, or a combination thereof.

4. A method of claim 1, further comprising:
determining one or more occurrence rates of one or more events at the product;
comparing the one or more occurrence rates to one or more other occurrence rates of the one or more events at one or more other products; and
recommending the one or more potential actions based on the comparing.

5. A method of claim 4, further comprising:
updating the one or more occurrence rates based on one or more information items determined by one or more service providers.

6. A method of claim 1, wherein the one or more parameters include a return transaction rate, a product order fulfillment accuracy, a product transaction frequency, a consumer information, a consumer location, a product type, a product manufacturer, or a combination thereof.

7. A method of claim 1, further comprising:
calculating a product reliability rate based on the one or more occurrence rates, one or more types of the one or more events, or a combination thereof.

8. A method of claim 7, further comprising:
determining a threshold value based on the product reliability rate; and
identifying one or more products with probability distribution rates above the threshold value.

9. A method of claim 1, further comprising:
determining one or more weight values for the one or more parameters; and
determining a ranking of the one or more parameters based on the one or more weight values.

10. An apparatus comprising:
a processor; and
a memory including computer program code for one or more programs,
the memory and the computer program code configured to, with the processor, cause the apparatus to perform at least the following:
determine one or more parameters associated with a transaction related to a product;
obtain, in response to the transaction and based on the one or more parameters, a metric describing a predicted operational status of the product; and
initiate a presentation, based on the metric, of one or more potential actions associated with the transaction and related to the product.

11. An apparatus of claim 10, wherein the transaction is a return transaction, and wherein the one or more potential actions include (1) performing additional troubleshooting of the product, (2) shipping the product to another location, or (3) a combination thereof.

12. An apparatus of claim 10, wherein the apparatus is further caused to:
generate the metric for a specific one of the product, a group of the product, another product related to the product, or a combination thereof.

13. An apparatus of claim 10, wherein the apparatus is further caused to:
determine one or more occurrence rates of one or more events at the product;
compare the one or more occurrence rates to one or more other occurrence rates of the one or more events at one or more other products; and
recommend the one or more potential actions based on the comparing.

14. An apparatus of claim 10, wherein the one or more parameters include a return transaction rate, a product order fulfillment accuracy, a product transaction frequency, a consumer information, a consumer location, a product type, a product manufacturer, or a combination thereof.

15. An apparatus of claim 10, wherein the apparatus is further caused to:
calculate a product reliability rate based on the one or more occurrence rates, one or more types of the one or more events, or a combination thereof.

16. An apparatus of claim 15, wherein the apparatus is further caused to:
determine a threshold value based on the product reliability rate; and
identify one or more products with probability distribution rates above the threshold value.

17. An apparatus of claim 10, wherein the apparatus is further caused to:
determine one or more weight values for the one or more parameters; and
determine a ranking of the one or more parameters based on the one or more weight values.

18. A system comprising:
a product transaction analysis server configured to:
determine one or more parameters associated with a transaction related to a product, wherein the transaction is a return transaction;
obtain, in response to the transaction and based on the one or more parameters, a metric describing a predicted operational status of the product; and
initiate a presentation, based on the metric, of one or more potential actions associated with the transaction and related to the product, wherein the one or more potential actions include (1) performing additional troubleshooting of the product, (2) shipping the product to another location, or (3) a combination thereof.

19. A system of claim 18, wherein the product transaction analysis server is further configured to generate the metric for a specific one of the product, a group of the product, another product related to the product, or a combination thereof.

20. A system of claim 18, wherein the product transaction analysis server is further configured to determine one or more occurrence rates of one or more events at the product; to compare the one or more occurrence rates to one or more other occurrence rates of the one or more events at one or more other products; and to recommend the one or more potential actions based on the comparing.
